(19) United States
(12) Patent Application Publication
(10) Pub. No.: US 2019/0266667 A1
(43) Pub. Date: Aug. 29, 2019

(54) METHOD AND APPARATUS FOR DISPLAYING PRODUCT DIFFERENCE INFORMATION, READABLE STORAGE MEDIUM, AND TERMINAL DEVICE

(71) Applicant: PING AN TECHNOLOGY (SHENZHEN) CO., LTD., Shenzhen, Guangdong (CN)

(72) Inventors: Guang LI, Shenzhen (CN); Jie DENG, Shenzhen (CN)

(21) Appl. No.: 16/319,803

(22) PCT Filed: Feb. 13, 2018
(86) PCT No.: PCT/CN2018/076660

§ 371 Date: Jan. 22, 2019

(30) Foreign Application Priority Data
Mar. 14, 2017 (CN) 201710149603.1

(51) Int. Cl. G06Q 40/02; G06F 3/14

(52) U.S. Cl. CPC G06Q 40/02; G06F 3/14

(57) ABSTRACT

The present application discloses a method and an apparatus for displaying product difference information, a readable storage medium, and a terminal device, which aims at solving the problem that product information of at least two products needs to be repeatedly switched so as to be comparatively checked during comparison of the at least two products. The method includes: obtaining product information of at least two target products to be compared; comparing the product information of the at least two target products to obtain difference information between the at least two target products; performing matching degree analysis on the at least two target products respectively according to user information of a current user and the product information to obtain a matching degree of each of the at least two target products with respect to the current user; determining corresponding preset highlighted display modes according to the matching degrees of the target products; and displaying the difference information corresponding to each of the at least two target products in the highlighted display mode corresponding to each of the at least two target products respectively.

The present application claims the priority of Chinese Patent Application No. 201710149603.1, filed with State Intellectual Property Office on Mar. 14, 2017, and entitled “METHOD AND APPARATUS FOR DISPLAYING PRODUCT DIFFERENCE INFORMATION”, the content of which is incorporated herein by reference in its entirety.

### TECHNICAL FIELD

The present application pertains to the field of financial services, and particularly, to a method and an apparatus for displaying product difference information, a computer readable storage medium, and a terminal device.

### BACKGROUND

There are various loan products in the market. When a user needs to choose loan products, the user often hesitates between two or among three loan products. At this moment, the user need to comparatively look over the product information of these loan products by switching among them, which reduces an efficiency of comparison among these loan products greatly, thus and hence thereby affecting sales of these loan products.

### SUMMARY

The present application provides a product difference information display method and apparatus, a computer readable storage medium, and a terminal device, which improve the efficiency of comparison between various products while facilitating check and comparison of various pieces of product information by users.

A first aspect of embodiments of the present application provides a product difference information display method, including:

obtaining product information of at least two target products to be compared;

comparing the product information of the at least two target products to obtain difference information among the at least two target products;

performing matching degree analysis on the at least two target products respectively according to user information of a current user and the product information to obtain a matching degree of each of the at least two target products to the current user;

determining corresponding preset highlighted display modes according to the matching degrees of the target products; and

displaying the difference information corresponding to each of the at least two target products in the highlighted display mode corresponding to each of the at least two target products, respectively;

where the higher the matching degree of the target product, the clearer the display effect of the highlighted display mode corresponding to the target product.

A second aspect of embodiments of the present application provides a computer readable storage medium having computer readable instructions stored thereon. When the computer readable instructions are executed by a processor, steps of the method for displaying product difference information proposed in the first aspect of the embodiments of the present application are achieved.

A third aspect of embodiments of the present application provides a terminal device, including a memory, a processor, and a computer readable instruction stored in the memory and executable on the processor. When the processor executes the computer readable instructions, steps of the method for displaying product difference information proposed in the first aspect of the embodiments of the present application are achieved.

A fourth aspect of embodiments of the present application provides an apparatus for displaying product difference information, including:

a product information acquisition module configured to obtain product information of at least two target products to be compared;

an information comparison module configured to obtain difference information between the at least two target products by comparing the product information of the at least two target products;

a matching degree analysis module configured to perform matching degree analysis on the at least two target products respectively according to user information of a current user and the product information to obtain a matching degree of each of the at least two target products to the current user;

a display mode determination module configured to determine corresponding preset highlighted display modes according to the matching degrees of the target products; and

a difference information display module configured to display the difference information corresponding to each of the at least two target products in the highlighted display mode corresponding to each of the at least two target products, respectively;

wherein the higher the matching degree of the target product, the clearer the display effect of the highlighted display mode corresponding to the target product.

In the present application, a user can check difference information among the at least two products conveniently. Moreover, the higher the matching degree of the product to the user, the better the highlighted display effect, and therefore, the users can check the product difference information with a high matching degree in first time more easily, which improves an efficiency of comparison among various products while facilitating the user in comparatively looking over various pieces of product information, thereby facilitating improving the sales efficiency of products.

### BRIEF DESCRIPTION OF DRAWINGS

FIG. 1 illustrates a flow chart of a method for displaying product difference information in an embodiment of the present application;

FIG. 2 illustrates a detailed schematic flow chart of step 102 of the method for displaying product difference information in the present application;

FIG. 3 illustrates a schematic flow chart of selection of difference information display mode of the method for displaying product difference information in the present application; and

FIG. 4 illustrates a structural block view of an apparatus for displaying product difference information in an embodiment of the present application.

### DESCRIPTION OF EMBODIMENTS

The present application provides a method and apparatus for displaying product difference information, which aims at solving the problem that product information of at least two products needs to be repeatedly switched so as to be comparatively looked over during comparison of these products.

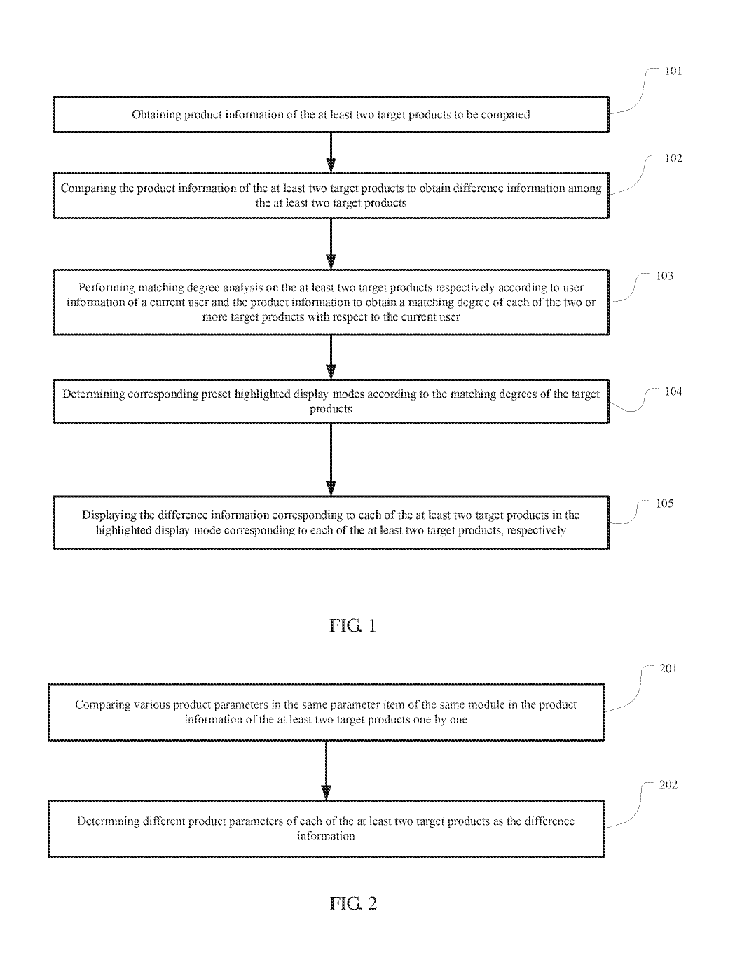

Referring to FIG. 1, an embodiment of a product difference information display method in the present application includes:

Step 101, obtaining product information of at least two target products to be compared.

In this embodiment, when a current user needs to compare at least two products, products to be compared in these products are first determined as target products, and then product information of each of these target products is obtained. For example, when the current user faces a plurality of loan products, the current user may determine two of these loan products as target products, assumed as product A and product B, and then product information of product A and product B is obtained, respectively. For the loan products, the product information may include sales term parameters, accounting term parameters, interest rate configuration parameters, cost parameters, transaction parameters and repayment sequence parameters and so on.

Step 102, comparing the product information of the at least two target products to obtain difference information between the at least two target products;

After the product information of each of the target products is obtained, difference information between the product information is found by comparing the product information. For example, if the interest of product A is 10% and the interest of product B is 10%, the interests of product A and product B are the same, and the interest is non-difference information. However, if the interest of product A is 10% and the interest of product B is 15%, the interests of product A and product B are same, and both the interest of product A and the interest of product B belong to the difference information between product A and product B.

Furthermore, in this embodiment, product parameters in the product information of the target products can be divided according to a preset module, the module may include one or more parameter items, and each of the parameter items includes one or more of the product parameters. During comparison of the product information, as shown in FIG. 2, step 102 may include:

Step 201, comparing various product parameters in the same parameter item of the same module in the product information of the at least two target products one by one.

Step 202, determining different product parameters of each of the at least two target products as the difference information.

Regarding steps 201 and 202, examples are as follows, and please refer to Table 1 below. As shown in Table 1, both product A and product B include a “sale term” module and an “accounting term” module, where the “sale term” module includes parameter items such as “guarantee type” and “funding source”, and the “accounting term” module includes parameter items such as “value date” and “repayment mode”. The product parameters in each of the parameter items are presented in Table 1 in a module or gridding form. By one-by-one comparison of various product parameters of product A and product B in the same parameter item of the same module it can be known that product parameters in the parameter items of “guarantee type” and “value date” between product A and product B are different, and these product parameters are determined as difference information between product A and product B, as shown in bold fonts in Table 1.

TABLE 1

| Module | Parameter | Product A | Product B |
|---|---|---|---|
| Sale term | Guarantee type | Guarantee | Insurance |
| | | company | |
| | Funding source | P2P | P2P |
| | . . . | | |
| Accounting | Value date | =Loan date | =Loan date + the |
| term | | | number N of days |
| | | | delayed on the |
| | | | value date |
| | Repayment mode | Average capital | Average capital |
| | | plus interest | plus interest |
| | . . . | | |
| . . . | . . . | | |

Step 103, performing matching degree analysis on the at least two target products respectively according to user information of a current user and the product information to obtain a matching degree of each of the at least two target products to the current user.

In this embodiment, after the product information of various target products is obtained, the matching degree calculation can be carried out according to the product information and the user information of the current user. For example, the product information and the user information of the current user are uploaded to a background big data server, and the big data server analyzes and calculates the matching degrees of these target products to the current user and then returns a matching degree result to the system of the present application. It can be understood that the user information may include tag information, credit information, customer relationship, consumption habits, and asset income, etc., and the big data server may assess loan product related contents fitting for the current user, such as the loan limit level, the mortgage, the installment span, and the repayment mode; and based on these assessed contents, different matching degrees can be converted for different target products. The matching degree is the degree of agreement between the target product and the assessed content. Moreover, the obtained matching degrees of these target products may also be displayed as the product information of the target products, as shown in Table 2.

TABLE 2

| Module | Parameter | Product A | Product B |
|---|---|---|---|
| Com- | Rec- | ▪▪▪▪▪▪▪□□□ | ▪▪□□□□□□□□ |
| parative | ommended | | |
| analysis | level | | |

In Table 2, the recommended level is the matching degree of each of product A and product B to the current user, and is presented in a level bar mode in Table 2. The more the “solid black boxes”, the higher the matching degree.

Furthermore, when the target products are loan products, in order to provide a faster, more convenient, and more efficient product selection mode for the user, if one of the target products meets a preset condition, the process directly skips to a preset contract payment process corresponding to the target product meeting the preset condition. The preset condition is that the matching degree of one of the target products is higher than a preset matching threshold, and is higher than the matching degrees of other target products in the at least two target products. It can be understood that in these target products, if the matching degree of one target product is higher than a preset threshold, and is much higher than the matching degree of each of the other target products, at this moment, the system may consider that this target product is most suitable for the current user, thus the process directly skips to the preset contract payment process corresponding to this target product, and the user may directly purchase the loan product without selecting the product. Of course, in some cases, after skipping to the contract payment process, if the current user does not want to purchase this loan product and wants to replace this loan product with another loan product, he/she can also skip out of the contract payment process and return to the specific process of the method for displaying product difference information in the present application.

Step 104, determining corresponding preset highlighted display modes according to the matching degrees of the target products.

Step 105, displaying the difference information corresponding to each of the at least two target products in the highlighted display mode corresponding to each of the at least two target products respectively, wherein the higher the matching degree of the target product, the clearer the display effect of the highlighted display mode corresponding to the target product.

Regarding aforementioned steps 104 and 105, in this embodiment, different highlighted display modes may be set according to different matching degrees in advance. Particularly, these highlighted display modes may include highlighted color, highlighted ground color (background color), and/or highlighted font size, as described below respectively:

When the highlighted display mode is the highlighted color, step 105 particularly includes: displaying the difference information corresponding to each of the at least two target products in a highlighted color corresponding to each of the at least two target products respectively; and at the same time, displaying non-difference information in the product information in a default color, wherein the highlighted color is different from the default color, and the higher the matching degree of the target product, the brighter the highlighted color corresponding to the target product. It can be known that a brighter font color is prone to attract the attention of the current user. In this embodiment, the difference information with a high matching degree uses brighter colors to the greatest extent, and the difference information with a low matching degree uses darker colors to the greatest extent.

When the highlighted display mode is the highlighted ground color, step 105 particularly includes: adjusting a background color of a location where the difference information locates as a highlighted ground color corresponding to each of the at least two target products when the difference information corresponding to each of the two or more target products is displayed; and displaying non-difference information in the product information, wherein a background color of a location where the non-difference information locates is a default ground color; wherein the highlighted ground color is different from the default ground color, and the higher the matching degree of the target product, the brighter the highlighted ground color corresponding to the target product.

When the highlighted display mode is the highlighted font size, step 105 particularly includes: displaying the difference information corresponding to each of the at least two target products in a highlighted font size corresponding to each of the at least two target products respectively; and at the same time, displaying non-difference information in the product information in a default font size, wherein the highlighted font size is bigger than the default font size, and the higher the matching degree of the target product, the bigger the highlighted font size corresponding to the target product. It can be understood that, due to the characteristics of human vision, a bigger font size is prone to attract the attention of the user. Therefore, the font size of the difference information with a high matching degree is bigger than the font size of the difference information with a low matching degree.

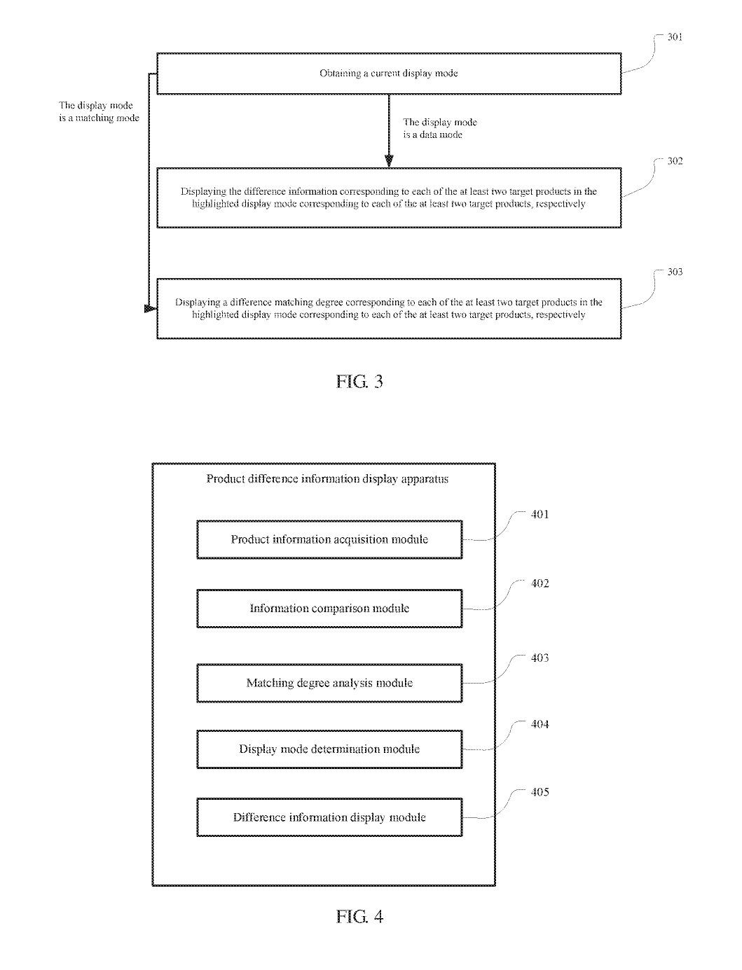

Furthermore, in order to provide the user with a more personalized difference information display mode, in the present application, as shown in FIG. 3, before step 105, the method may further include:

Step 301, obtaining a current display mode;

Step 302, executing step 105 if the display mode is a preset data mode.

Step 303, displaying a difference matching degree corresponding to each of the at least two target products in the highlighted display mode corresponding to each of the at least two target products respectively If the display mode is a preset matching mode, wherein the difference matching degree is a matching degree of the difference information with respect to the current user.

Regarding steps 301-303, this embodiment provides the user with two difference information display modes, that is, a data mode and a matching mode.

The data mode is presenting the aforementioned difference information in a data form, as shown in Table 3 below.

TABLE 3

| Module | Parameter | Product A | Product B |
|---|---|---|---|
| Comparative | Rec- | ▪▪▪▪▪▪▪□□□ | ▪▪□□□□□□□□ |
| analysis | ommended | | |
| | level | | |
| Sale term | Guarantee | Guarantee | Insurance |
| | type | company | |
| | Funding | P2P | P2P |
| | source | | |
| | . . . | | |
| Accounting | Value date | =Loan date | =Loan date + the |
| term | | | number N of |
| | | | days delayed on |
| | | | the value date |
| | Repayment | Average capital | Average capital |
| | mode | plus interest | plus interest |
| | . . . | | |
| . . . | . . . | | |

In Table 3, due to the particularity of the matching degree, it is presented in a level bar form, and the remaining difference information is presented in a data form.

In addition, the matching mode means that the aforementioned difference information is presented in a matching degree form, that is, a form similar to the level bar of the aforementioned “matching degree”, as shown in Table 4 below.

TABLE 4

| Module | Parameter | Product A | Product B |
|---|---|---|---|
| Comparative | Recommended | ▪▪▪▪▪▪▪□□□ | ▪▪□□□□□□□□ |
| analysis | level | | |
| Sale term | Guarantee type | ▪▪▪▪▪▪▪▪▪□ | ▪▪▪▪□□□□□□ |
| | Funding | P2P | P2P |
| | source | | |
| | . . . | | |
| Accounting | Value date | ▪▪▪▪▪▪▪▪▪▪ | ▪▪□□□□□□□□ |
| term | Repayment | Average capital | Average capital |
| | mode | plus interest | plus interest |
| | . . . | | |
| . . . | . . . | | |

In this embodiment, the current user can select and switch the data mode and the matching mode by himself/herself in a expression page according to his/her own needs.

It can be known from the contents above that in this embodiment, users can check difference information among at least two products conveniently. Moreover, the higher the matching degree of the product to the user, the better the highlighted display effect, and therefore, the users can check the product difference information with a high matching degree in first time more easily, which improves an efficiency of comparison among various products while facilitating the user in comparatively looking over various pieces of product information, thereby facilitating improving the sales efficiency of products.

The method for displaying product difference information are mainly described above, and an apparatus for displaying product difference information will be described in detail below.

FIG. 4 is a structural block view of an apparatus for displaying product difference information in an embodiment of the present application.

In this embodiment, the apparatus for displaying product difference information includes:

a product information acquisition module 401 configured to acquire product information of at least two target products to be compared;

an information comparison module 402 configured obtain difference information between the at least two target products by comparing the product information of the at least two target products;

a matching degree analysis module 403 configured to perform matching degree analysis on the at least two target products respectively according to user information of a current user and the product information to obtain a matching degree of each of the at least two target products with respect to the current user;

a display mode determination module 404 configured to determine corresponding preset highlighted display modes according to the matching degrees of the target products; and

a difference information display module 405 configured to display the difference information corresponding to each of the at least two target products in the highlighted display mode corresponding to each of the at least two target products, respectively;

wherein the higher the matching degree of the target product, the clearer the display effect of the highlighted display mode corresponding to the target product.

Furthermore, product parameters in the product information can be divided according to a preset module, the module includes one or more parameter items, and each of the parameter items includes one or more of the product parameters.

The information comparison module includes:

a product parameter comparison unit configured to compare various product parameters in the same parameter item of the same module in the product information of the at least two target products one by one; and

a difference information determining unit configured to determine different product parameters of each of the at least two target products as the difference information.

Furthermore, the product difference information display apparatus may include:

a display mode acquisition module configured to obtain a display mode;

a trigger module configured to trigger the difference information display module if the display mode is a preset data mode; and

a difference matching degree display module configured to display, if the display mode is a preset matching mode, a difference matching degree corresponding to each of the at least two target products in the highlighted display mode corresponding to each of the at least two target products respectively, wherein the difference matching degree is a matching degree of the difference information with respect to the current user.

Furthermore, the target products are loan products.

The product difference information display apparatus may further include:

a contract skipping module configured to directly skip to, if one of the target products meets a preset condition, a preset contract payment process corresponding to the target product meeting the preset condition, wherein the preset condition is that the matching degree of one of the target products is higher than a preset matching threshold, and is higher than matching degrees of other target products in the at least two target products.

Furthermore, the difference information display module may include:

a color highlighting unit configured to display the difference information corresponding to each of the at least two target products in a highlighted color corresponding to each of the at least two target products respectively; and a default color display unit configured to display non-difference information in the product information in a default color; wherein the highlighted color is different from the default color, and the higher the matching degree of the target product is, the brighter the highlighted color corresponding to the target product is;

and/or

a font size highlighting unit configured to display the difference information corresponding to each of the at least two target products in a highlighted font size corresponding to each of the at least two target products respectively; and a default font size display unit configured to display non-difference information in the product information in a default font size;

wherein the highlighted font size is greater than the default font size, and the higher the matching degree of the target product, the greater the highlighted font size corresponding to the target product;

and/or

a ground color highlighting unit configured to adjust, when the difference information corresponding to each of the at least two target products is displayed, a background color of a location where the difference information locates as a highlighted ground color corresponding to each of the at least two target products;

and

a default ground color display unit configured to display non-difference information in the product information, wherein a background color of a location where the non-difference information locates is a default ground color;

the highlighted ground color is different from the default ground color, and the higher the matching degree of the target product, the brighter the highlighted ground color corresponding to the target product.

The ordinarily skilled one in the art can clearly understand that, as for the specific working process of the system, apparatus and units described above, reference can be made to the corresponding process in the foregoing method embodiments, and details are not repeatedly described herein again.

Embodiments of the present application further provide a computer readable storage medium having computer readable instructions stored thereon. When the computer readable instructions are executed by a processor, steps of any product difference information display method as shown in FIG. 1 are achieved.

Embodiments of the present application further provide a terminal device, including a memory, a processor, and computer readable instructions stored in the memory and executable on the processor. When the processor executes the computer readable instructions, steps of any method for displaying product difference information as shown in FIG. 1 are achieved.

1. A method for displaying product difference information, comprising:
obtaining product information of at least two target products to be compared;
comparing the product information of the at least two target products to obtain difference information among the at least two target products;
performing matching degree analysis on the at least two target products respectively according to user information of a current user and the product information to obtain a matching degree of each of the at least two target products with respect to the current user, respectively;
determining a corresponding preset highlighted display mode according to the matching degree of the target products; and
displaying the difference information corresponding to each of the at least two target products in the highlighted display mode corresponding to each of the at least two target products, respectively;
wherein the higher the matching degree of the target product, the clearer the display effects of the highlighted display modes corresponding to the target products.

2. The method for displaying product difference information according to claim 1, wherein product parameters in the product information are divided according to a preset module, the module comprises one or more parameter items, and each of the parameter items includes one or more of the product parameters;
the step of comparing the product information of the at least two target products to obtain difference information among the at least two target products comprises:
comparing various product parameters in the same parameter item of the same module in the product information of the at least two target products one by one; and
determining product parameters of each of the at least two target products which are different by comparison as the difference information.

3. The method for displaying product difference information according to claim 1, wherein before the step of displaying the difference information corresponding to each of the at least two target products in the highlighted display mode corresponding to each of the at least two target products respectively, the method further comprises:
obtaining a current display mode;
executing the step of displaying the difference information corresponding to each of the at least two target products in the highlighted display modes corresponding to the at least two target products respectively, if the display mode is a preset data mode;
displaying a difference matching degree corresponding to each of the at least two target products in the highlighted display mode corresponding to each of the at least two target products respectively if the display mode is a preset matching mode, wherein the difference matching degree is a matching degree of the difference information with respect to the current user.

4. The method for displaying product difference information according to claim 1, wherein the target products are loan products;
after the step of performing matching degree analysis on the at least two target products respectively according to user information of a current user and the product information to obtain a matching degree of each of the at least two target products to the current user, the method further comprises:
if one of the target products meets a preset condition, directly skipping to a preset contract payment process corresponding to the target product that meets the preset condition, wherein the preset condition is that the matching degree of one of the target products is higher than a preset matching threshold, and is higher than matching degrees of other target products in the at least two target products.

5. The method for displaying product difference information according to claim 1, wherein the step of displaying the difference information corresponding to each of the at least two target products in the highlighted display mode corresponding to each of the at least two target products respectively comprises:
displaying the difference information corresponding to each of the at least two target products in a highlighted color corresponding to each of the at least two target products respectively; and
displaying non-difference information in the product information in a default color; wherein the highlighted color is different from the default color, and the higher the matching degree of the target product, the brighter the highlighted color corresponding to the target product;
and/or
displaying the difference information corresponding to each of the at least two target products in a highlighted font size corresponding to each of the at least two target products respectively; and
displaying non-difference information in the product information in a default font size;
wherein the highlighted font size is greater than the default font size, and the higher the matching degree of the target product, the bigger the highlighted font size corresponding to the target product;
and/or
adjusting a background color of a location where the difference information locates as a highlighted ground color corresponding to each of the at least two target products, when the difference information corresponding to each of the at least two target products is displayed; and
displaying non-difference information in the product information, wherein a background color of a location where the non-difference information is located is a default ground color;
the highlighted ground color is different from the default ground color, and the higher the matching degree of the target product, the brighter the highlighted ground color corresponding to the target product.

6. A computer readable storage medium having computer readable instructions stored thereon, wherein when executing the computer readable instructions, a processor implements the following steps of:
obtaining product information of at least two target products to be compared;
comparing the product information of the at least two target products to obtain difference information among the at least two target products;
performing matching degree analysis on the at least two target products respectively according to user information of a current user and the product information to obtain a matching degree of each of the at least two target products to the current user;
determining corresponding preset highlighted display modes according to the matching degrees of the target products; and
displaying the difference information corresponding to each of the at least two target products in the highlighted display mode corresponding to each of the at least two target products, respectively;
wherein the higher the matching degree of the target product, the clearer the display effect of the highlighted display mode corresponding to the target product.

7. The computer readable storage medium according to claim 6, wherein
product parameters in the product information are divided according to a preset module, the module comprises one or more parameter items, and each of the parameter items comprises one or more of the product parameters;
the step of comparing the product information of the at least two target products to obtain difference information among the at least two target products comprises:
comparing various product parameters in the same parameter item of the same module in the product information of the at least two target products one by one; and
determining product parameters of each of the at least two target products which are different by comparison as the difference information.

8. The computer readable storage medium according to claim 6, wherein before displaying the difference information corresponding to each of the at least two target products in the highlighted display mode corresponding to each of the at least two target products respectively, the method further comprises:
obtaining a current display mode;
executing, if the display mode is a preset data mode, the step of displaying the difference information corresponding to each of the at least two target products in the highlighted display mode corresponding to each of the at least two target products respectively; and
displaying, if the display mode is a preset matching mode, a difference matching degree corresponding to each of the at least two target products in the highlighted display mode corresponding to each of the at least two target products respectively, wherein the difference matching degree is a matching degree of the difference information with respect to the current user.

9. The computer readable storage medium according to claim 6, wherein the target products are loan products;
after the step of performing matching degree analysis on the at least two target products respectively according to user information of a current user and the product information to obtain a matching degree of each of the at least two target products with respect to the current user, the step further comprises:
directly skipping to a preset contract payment process corresponding to the target product satisfying a preset condition if one of the target products satisfies the preset condition, wherein the preset condition is that the matching degree of one of the target products is higher than a preset matching threshold, and is higher than matching degrees of other target products in the at least two target products.

10. The computer readable storage medium according to claim 6, wherein the step of displaying the difference information corresponding to each of the at least two target products in the highlighted display mode corresponding to each of the at least two target products respectively comprises:
displaying the difference information corresponding to each of the at least two target products in a highlighted color corresponding to each of the at least two target products respectively; and
displaying non-difference information in the product information in a default color;
the highlighted color is different from the default color, and the higher the matching degree of the target product is, the brighter the highlighted color corresponding to the target product is;
and/or
displaying the difference information corresponding to each of the at least two target products in a highlighted font size corresponding to each of the at least two target products respectively; and
displaying non-difference information in the product information in a default font size;
wherein the highlighted font size is bigger than the default font size, and the higher the matching degree of the target product, the bigger the highlighted font size corresponding to the target product;
and/or
when the difference information corresponding to each of the at least two target products is displayed, adjusting a background color of a location where the difference information locates as a highlighted ground color corresponding to each of the at least two target products; and
displaying non-difference information in the product information, wherein a background color of a location where the non-difference information locates is a default ground color;
the highlighted ground color is different from the default ground color, and the higher the matching degree of the target product, the brighter the highlighted ground color corresponding to the target product.

11. A terminal device, comprising a memory, a processor, and a computer readable instruction stored in the memory and executable on the processor, wherein when executing the computer readable instruction, the processor implements the following steps of:
obtaining product information of at least two target products to be compared;
comparing the product information of the at least two target products to obtain difference information among the at least two target products;
performing matching degree analysis on the at least two target products respectively according to user information of a current user and the product information to obtain a matching degree of each of the at least two target products to the current user;
determining corresponding preset highlighted display modes according to the matching degrees of the target products; and
displaying the difference information corresponding to each of the at least two target products in the highlighted display mode corresponding to each of the at least two target products, respectively;
wherein the higher the matching degree of the target product, the clearer the display effect of the highlighted display mode corresponding to the target product.

12. The terminal device according to claim 11, wherein product parameters in the product information are divided according to a preset module, the module comprises one or more parameter items, and each of the parameter items comprises one or more of the product parameters;
the step of comparing the product information of the at least two target products to obtain difference information among the at least two target products comprises:
comparing various product parameters in the same parameter item of the same module in the product information of the at least two target products one by one; and
determining product parameters of each of the at least two target products which are different by comparison as the difference information.

13. The terminal device according to claim 11, wherein before displaying the difference information corresponding to each of the at least two target products in the highlighted display mode corresponding to each of the at least two target products respectively, the step further comprises:
obtaining a current display mode;
executing the step of displaying the difference information corresponding to each of the at least two target products in the highlighted display mode corresponding to each of the at least two target products respectively, if the display mode is a preset data mode; and
displaying a difference matching degree corresponding to each of the at least two target products in the highlighted display mode corresponding to each of the at least two target products respectively if the display mode is a preset matching mode, wherein the difference matching degree is a matching degree of the difference information with respect to the current user.

14. The terminal device according to claim 11, wherein the target products are loan products;
after the step of performing matching degree analysis on the at least two target products respectively according to user information of a current user and the product information to obtain a matching degree of each of the at least two target products to the current user, the method further comprises:
if one of the target products satisfies a preset condition, directly skipping to a preset contract payment process corresponding to the target product satisfying the preset condition, wherein the preset condition is that the matching degree of one of the target products is higher than a preset matching threshold, and is higher than matching degrees of other target products in the at least two target products.

15. The terminal device according to claim 11, wherein the step of displaying the difference information corresponding to each of the at least two target products in the highlighted display mode corresponding to each of the at least two target products respectively comprises:
displaying the difference information corresponding to each of the at least two target products in a highlighted color corresponding to each of the at least two target products respectively; and
displaying non-difference information in the product information in a default color; wherein the highlighted color is different from the default color, and the higher the matching degree of the target product, the brighter the highlighted color corresponding to the target product;
and/or
displaying the difference information corresponding to each of the at least two target products in a highlighted font size corresponding to each of the at least two target products respectively; and
displaying non-difference information in the product information in a default font size; wherein the highlighted font size is bigger than the default font size, and the higher the matching degree of the target product, the bigger the highlighted font size corresponding to the target product;
and/or
adjusting a background color of a location where the difference information locates as a highlighted ground color corresponding to each of the at least two target products, when the difference information corresponding to each of the more than target products is displayed; and
displaying non-difference information in the product information, wherein a background color of a location where the non-difference information locates is a default ground color; wherein the highlighted ground color is different from the default ground color, and the higher the matching degree of the target product, the brighter the highlighted ground color corresponding to the target product.

16-20. (canceled)

21. The method for displaying product difference information according to claim 2, wherein the step of displaying the difference information corresponding to each of the at least two target products in the highlighted display mode corresponding to each of the at least two target products respectively comprises:
displaying the difference information corresponding to each of the at least two target products in a highlighted color corresponding to each of the at least two target products respectively; and
displaying non-difference information in the product information in a default color; wherein the highlighted color is different from the default color, and the higher the matching degree of the target product, the brighter the highlighted color corresponding to the target product;
and/or
displaying the difference information corresponding to each of the at least two target products in a highlighted font size corresponding to each of the at least two target products respectively; and
displaying non-difference information in the product information in a default font size;
wherein the highlighted font size is greater than the default font size, and the higher the matching degree of the target product, the bigger the highlighted font size corresponding to the target product;
and/or
adjusting a background color of a location where the difference information locates as a highlighted ground color corresponding to each of the at least two target products, when the difference information corresponding to each of the at least two target products is displayed; and
displaying non-difference information in the product information, wherein a background color of a location where the non-difference information is located is a default ground color;
the highlighted ground color is different from the default ground color, and the higher the matching degree of the target product, the brighter the highlighted ground color corresponding to the target product.

22. The method for displaying product difference information according to claim 3, wherein the step of displaying the difference information corresponding to each of the at least two target products in the highlighted display mode corresponding to each of the at least two target products respectively comprises:
displaying the difference information corresponding to each of the at least two target products in a highlighted color corresponding to each of the at least two target products respectively; and
displaying non-difference information in the product information in a default color; wherein the highlighted color is different from the default color, and the higher the matching degree of the target product, the brighter the highlighted color corresponding to the target product;
and/or
displaying the difference information corresponding to each of the at least two target products in a highlighted font size corresponding to each of the at least two target products respectively; and
displaying non-difference information in the product information in a default font size;
wherein the highlighted font size is greater than the default font size, and the higher the matching degree of the target product, the bigger the highlighted font size corresponding to the target product;
and/or
adjusting a background color of a location where the difference information locates as a highlighted ground color corresponding to each of the at least two target products, when the difference information corresponding to each of the at least two target products is displayed; and
displaying non-difference information in the product information, wherein a background color of a location where the non-difference information is located is a default ground color;
the highlighted ground color is different from the default ground color, and the higher the matching degree of the target product, the brighter the highlighted ground color corresponding to the target product.

23. The method for displaying product difference information according to claim 4, wherein the step of displaying the difference information corresponding to each of the at least two target products in the highlighted display mode corresponding to each of the at least two target products respectively comprises:
displaying the difference information corresponding to each of the at least two target products in a highlighted color corresponding to each of the at least two target products respectively; and
displaying non-difference information in the product information in a default color; wherein the highlighted color is different from the default color, and the higher the matching degree of the target product, the brighter the highlighted color corresponding to the target product;
and/or
displaying the difference information corresponding to each of the at least two target products in a highlighted font size corresponding to each of the at least two target products respectively; and
displaying non-difference information in the product information in a default font size;
wherein the highlighted font size is greater than the default font size, and the higher the matching degree of the target product, the bigger the highlighted font size corresponding to the target product;
and/or
adjusting a background color of a location where the difference information locates as a highlighted ground color corresponding to each of the at least two target products, when the difference information corresponding to each of the at least two target products is displayed; and
displaying non-difference information in the product information, wherein a background color of a location where the non-difference information is located is a default ground color;
the highlighted ground color is different from the default ground color, and the higher the matching degree of the target product, the brighter the highlighted ground color corresponding to the target product.

24. The computer readable storage medium according to claim 7, wherein the step of displaying the difference information corresponding to each of the at least two target products in the highlighted display mode corresponding to each of the at least two target products respectively comprises:
displaying the difference information corresponding to each of the at least two target products in a highlighted color corresponding to each of the at least two target products respectively; and
displaying non-difference information in the product information in a default color;
the highlighted color is different from the default color, and the higher the matching degree of the target product is, the brighter the highlighted color corresponding to the target product is;
and/or
displaying the difference information corresponding to each of the at least two target products in a highlighted font size corresponding to each of the at least two target products respectively; and
displaying non-difference information in the product information in a default font size;
wherein the highlighted font size is bigger than the default font size, and the higher the matching degree of the target product, the bigger the highlighted font size corresponding to the target product;
and/or
when the difference information corresponding to each of the at least two target products is displayed, adjusting a background color of a location where the difference information locates as a highlighted ground color corresponding to each of the at least two target products; and
displaying non-difference information in the product information, wherein a background color of a location where the non-difference information locates is a default ground color;
the highlighted ground color is different from the default ground color, and the higher the matching degree of the target product, the brighter the highlighted ground color corresponding to the target product.

25. The terminal device according to claim 12, wherein the step of displaying the difference information corresponding to each of the at least two target products in the highlighted display mode corresponding to each of the at least two target products respectively comprises:
displaying the difference information corresponding to each of the at least two target products in a highlighted color corresponding to each of the at least two target products respectively; and
displaying non-difference information in the product information in a default color; wherein the highlighted color is different from the default color, and the higher the matching degree of the target product, the brighter the highlighted color corresponding to the target product;
and/or
displaying the difference information corresponding to each of the at least two target products in a highlighted font size corresponding to each of the at least two target products respectively; and
displaying non-difference information in the product information in a default font size; wherein the highlighted font size is bigger than the default font size, and the higher the matching degree of the target product, the bigger the highlighted font size corresponding to the target product;
and/or
adjusting a background color of a location where the difference information locates as a highlighted ground color corresponding to each of the at least two target products, when the difference information corresponding to each of the more than target products is displayed; and
displaying non-difference information in the product information, wherein a background color of a location where the non-difference information locates is a default ground color; wherein the highlighted ground color is different from the default ground color, and the higher the matching degree of the target product, the brighter the highlighted ground color corresponding to the target product.
